(19) United States
(12) Patent Application Publication
(10) Pub. No.: US 2005/0093859 A1
(43) Pub. Date: May 5, 2005

(54) Viewing direction dependent acquisition or processing for 3D ultrasound imaging

(75) Inventors: Thilaka S. Sumanaweera, Los Altos, CA (US); Kutay F. Ustuner, Mountain View, CA (US)

Correspondence Address: Siemens Corporation;Intellectual Property Department, 170 Wood Avenue South, Iselin, NJ, 08830, US

(73) Assignee: Siemens Medical Solutions USA, Inc.

(21) Appl. No.: 10/701,910

(22) Filed: Nov. 4, 2003

(51) Int. Cl. G06T 15/00

(52) U.S. Cl. 345/419

(57) ABSTRACT

To improve real time 3D imaging performance, acquisition, beamforming, coherent image forming and/or image processing parameters are varied as a function of the viewing direction selected by the user. For example, the scan planes are oriented relative to the viewing direction. As a result rapid 3D rendering is provided without complex additional data interpolation or other 3D rendering processes. In another example, data along the lateral axis that is perpendicular to the viewing direction (i.e., display lateral axis) is acquired with parameters adapted to maximize field of view, detail and contrast resolution, while data along the lateral axis that is parallel to the viewing direction is acquired with compromised field of view, detail or contrast resolution. As a result, a high volume rate 3D imaging is achieved with 2D-equivalent detail resolution, contrast resolution and field of view along the display lateral axis.

### BACKGROUND

The present invention relates to three-dimensional (3D) imaging. In particular, 3D imaging using ultrasound data is provided.

For 3D imaging of a volume or 4D imaging of the volume over time, ultrasound data is acquired and processed along an array-based coordinate system. For example, the row and column axes of a two-dimensional (2D) planar array define the x and y axes of a Cartesian coordinate system. Planes or a pattern defined on the array-based coordinate system are scanned to acquire data on a 3D sampling grid. The data is used for beamformation, image formation and image processing to form images on a 3D grid defined on the array-based coordinate system. The images are volume rendered as a function of the user viewing direction to obtain display images, which are 2D representations of 3D images where the information in the third dimension is used to further modulate the brightness or color. The horizontal and vertical axes of the 2D display are orthogonal to the user's viewing axis and rotate relative to the array-based coordinates as the user changes the viewing direction. The user's viewing direction is an input to the volume rendering process.

### BRIEF SUMMARY

To improve 3D imaging performance, one or more of the acquisition, beamforming, coherent image forming and/or image processing parameters are varied as a function of the viewing direction selected by the user. In one example embodiment, the scan planes are oriented relative to the viewing direction such that the lateral axis of the scan planes is perpendicular to the user's viewing direction, and therefore aligned with the horizontal display axis. Each scan plane is spaced at a different position along the axis parallel to the viewing axis (the display normal). The data is then foreshortened in the axial scan plane axis, the shortening rate being a function of the projected height of the respective scan plane on the vertical display axis. The foreshortened scan planes are combined and scan converted to form a 2D representation of the 3D volume (i.e., volume rendering). As a result, fast real-time 3D rendering is provided without complex additional data interpolation or other 3D rendering processes.

In another example, data along the lateral axis that is perpendicular to the viewing direction (i.e., display lateral axis) is acquired with parameters adapted to maximize field of view, detail and contrast resolution, while data along the lateral axis that is parallel to the viewing direction is acquired with compromised field of view, detail or contrast resolution. As a result, high volume rate 3D imaging is achieved with 2D-equivalent detail resolution, contrast resolution and field of view along the display lateral axis.

In a first aspect, a method for acquiring ultrasound data in 3D imaging is provided. A viewing direction is determined relative to a 3D space. An acquisition parameter is set as a function of the viewing direction. The acquisition parameters are the parameters that control the scan geometry, scan pattern, firing sequence, data-sampling rate (e.g., beam density, lateral sampling grid and beam distribution), combinations thereof etc. For example, positions of a set of scan planes are set as a function of the viewing direction. 3D ultrasound data is acquired as a function of the acquisition parameter.

In a second aspect, a method for beamforming in 3D imaging is provided. A viewing direction is determined relative to a 3D space. A beamforming parameter is set as a function of the viewing direction. The beamforming parameters include apodization, delay, number of substantially simultaneous beams on transmit and/or receive. The beamforming parameters also include any parameters that affect the pre-detection temporal response since the lateral response is directly coupled with the temporal response. The temporal response parameters that affect beamforming include the transmit modulation frequency, transmit complex envelope, transmit filters, transmit pulse count, receive demodulation frequency, receive axial filters, transmit aperture size, receive aperture size, cyclic phase aperture pattern, cyclic amplitude aperture pattern, combinations thereof etc. 3D ultrasound data is beamformed as a function of the beamforming parameter.

In a third aspect, a method for coherent imageforming in 3D imaging is provided. A viewing direction is determined relative to a 3D space. A coherent image forming parameter is set as a function of the viewing direction. The coherent image forming parameters include: parameters of the lateral (i.e., across beams) filters, the interpolator prior to amplitude detection after beamformation, an amount of coherent processing in azimuth of beams, a lateral filter variable, and combinations thereof. The lateral filters include beam averaging and weighted beam averaging (also known as Synthesis). The lateral filtering may be followed by lateral decimation. The beams averaged may belong to the same transmit beam or different transmit beams. The coherent imageforming may follow a lateral phase alignment. For example, the line interpolation rate is set as a function of the viewing direction. 3D ultrasound data is interpolated as a function of the coherent imageforming parameter.

In a fourth aspect, a method for image processing in 3D imaging is provided. A viewing direction is determined relative to a 3D space. An image processing parameter is set as a function of the viewing direction. The image processing parameters include: parameters of the filters, an amount of spatial compounding, post-detection beam averaging, an amount of frequency compounding, an amount of lateral filtering, an amount of lateral gain, an adaptive processing value, an axial response value, an amount of incoherent summation in elevation of beams responsive to different transmit events, the interpolator post detection prior to volume rendering, combinations thereof, etc. The post-detection filters include linear, nonlinear and adaptive spatial filters, as well as beam averaging and weighted beam averaging (also known as Compounding). The beams averaged may belong to the same transmit beam or different transmit beams. The lateral filtering may be followed by decimation. For example, lateral filter parameters are set as a function of the viewing direction. 3D ultrasound data is filtered as a function of the image processing parameter.

In a fifth aspect, a method for volume rendering for 3D ultrasound imaging is provided. A viewing direction is determined relative to a 3D space. 2D scans are performed along planes with lateral axes that are substantially perpendicular to the viewing direction. 2D scans are foreshortened in the axial direction as a function of viewing direction and summed for volume rendering.

In a sixth aspect, a system for 3D imaging of ultrasound data is provided. An acquisition controller connects with a transducer and beamformer. A user input is operative to receive a selected viewing direction. The acquisition controller is responsive to the selected viewing direction.

The present invention is defined by the following claims, and nothing in the section above should be taken as a limitation on those claims. Further aspects and advantages of the invention are discussed below in conjunction with the preferred embodiments. Some preferred embodiments may only provide some but not all of the advantages discussed herein. Other useful embodiments of the invention may provide none of the advantages discussed herein, but may provide other advantages.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for 3D imaging;

FIG. 2 is a flow chart diagram of one embodiment of a method for acquiring ultrasound data in volume rendering;

FIGS. 3 thru 7 are graphical representations of the various embodiments of a scan coordinate system relative to a viewing direction;

FIG. 8 is a graphical representation of one embodiment of a geometric relationship between the viewing direction and scan planes;

FIG. 9 is a graphical representation of a perceived size of the scan planes of FIG. 8 from the viewing direction; and

FIG. 10 is a graphical representation showing a geometric relationship of the viewing direction to acquired data.

### DETAILED DESCRIPTION OF THE DRAWINGS AND PRESENTLY PREFERRED EMBODIMENTS

Parameters for acquiring and/or processing ultrasound data are set or altered as a function of the viewing direction or changes in the viewing direction. Data along the lateral axis that is perpendicular to the viewing direction (i.e., display lateral axis) is acquired with parameters adapted to maximize field of view, detail and contrast resolution, while data along the lateral axis that is parallel to the viewing direction is acquired with compromised field of view, detail or contrast resolution. As a result, high volume rate 3D imaging is achieved with 2D-equivalent detail resolution, contrast resolution and field of view along the display lateral axis. While maximum is discussed above, less then the maximum may be used.

Acquisition parameters defining the position of a scan plane are varied as a function of the viewing direction in one embodiment. As a result, the acquisition coordinate system varies as a function of the user's viewing direction. The three or four dimensional ultrasound data is acquired on the acquisition coordinate system, enabling volume rendering with low cost back end hardware. By aligning the acquisition coordinates with the display coordinates, volume rendering is performed with geometry and persistence engines of conventional ultrasound scanners. Volume rendering using a graphics processing or control unit may alternatively be used.

FIG. 1 shows one embodiment of a system 11 for 3D imaging of ultrasound data. The system 11 includes a transducer 12, a beamformer 14, an acquisition or beamformer controller 16, a user interface 18, a detector 20, a geometry processor 22, a filter 24, and a display 26. Additional different or fewer components may be provided. For example, additional filters are provided before or after the detector 20. As yet another example, the system 11 includes an acquisition system with a separate work station for processing the data. As another example, a scan converter is provided after the filter 24. Other arrangements of the components may be provided, such as providing the detector 20 before or after either of the geometry processor 22 and the filter 24.

The transducer 12 is a linear, 2D, other multi-dimensional or wobbler array of elements. For 3D imaging, the transducer 12 is operable to scan within a volume. For example, a one dimensional linear array of elements scans within a plane and is positioned at different angles or locations to scan different scan planes. As another example, the transducer 12 is a multi-dimensional transducer array operable to electronically steer ultrasound energy to different locations within a volume. As yet another example, a linear array electronically steers along one dimension and is mechanically steered along a different dimension. For mechanical or user guided steering, an assumed steering direction is used, sensors on the transducer 12 indicate a location of the transducer doing a scan, or ultrasound data is processed to determine an amount of movement between different scans. Any other now known or later developed transducer and 3D imaging position techniques may be used.

The beamformer 14 includes a transmit and/or receive beamformer. Analog or digital beamformers may be used. The beamformer 14 includes amplifiers, delays, phase rotators, summers, and other digital or electronic circuits. In one embodiment, the beamformer 14 is one of the beamformers disclosed in U.S. Pat. No. 5,675,554, the disclosure of which is incorporated herein by reference. In another embodiment, the beamformer 14 has a plane wave transmit beamformer with a receive beamformer operable to generate data representing different spatial locations in response to the plane wave transmission. In other embodiments, the beamformer 14 includes one of the receive beamformers disclosed in U.S. Pat. No. 5,685,308, the disclosure of which is incorporated herein by reference. Other beamformers with separate components or hardware for implementing any of the beamforming or acquisition parameters discussed herein may be used. The beamformer 14, whether as a single component or a group of components, is responsive to one or more parameters the affect the pre-detection temporal response, such as the transmit modulation frequency, transmit complex envelope, transmit filters, transmit aperture size, transmit pulse count, receive demodulation frequency, receive axial filters, receive aperture size, apodization, delay profile or others.

The beamformer 14 is operable to cause the transducer 12 to scan a 3D volume and receive responsive echo signals. For example, the beamformer 14 switchably connects with elements of the transducer 12 to generate a transmit aperture in any of various positions on a 2D transducer array. The scan format, such as sector, Vector®, linear or other now know or later developed scan formats for 2D imaging is controlled or set by the beamformer 14. The angle of a scan plane to the transducer is set as a function of focusing delays, apodizations and aperture size and placement. The angle of a given transmit beam within a 2D plane, the angle of a transmit beam within 3D space, or the angle of a scan plane within 3D space is controlled by the beamformer 14. In alternative embodiments, the user or a different controller provides some of the steering, such as associated with a wobbler or mechanically steered transducer. A mechanical adjustment may also be provided for adjusting the position and aperture relative to a 3D volume.

The beamformer controller 16 is a general processor, application specific integrated circuit, digital signal processor, group of processors, digital circuit, analog circuit, and combinations thereof for controlling the beamformer 14. In one embodiment, the beamform controller 16 includes some components that are separate for the transmit and receive beamform operations and one or more components in common for controlling both transmit and receive operations. For example, the transmit beamformer controllers disclosed in U.S. Pat. No. 5,581,517, the disclosure of which is incorporated herein by reference, are used. Other now known or later developed beamformer controllers may be used. The beamform controller 16 connects with the beamformer 14 to control operation of the beamformer 14, such as controlling the acquisition parameters (e.g., scan geometry, scan pattern, firing sequence, data-sampling rate or other acquisition parameters.

The beamformer controller 16 is operative to set a parameter of the beamformer, such as an aperture, delay profile, apodization profile, transmit frequency, number of cycles of a transmit waveform, combination of coherent data, filtering, analytic line interpolation, receive frequency, demodulation frequency, baseband filter, weights, or other now known or later developed beamforming parameters as well as the acquisition parameters discussed above. Beamformer parameters are set by the controller 16 based on various considerations, such as user selected imaging application, the type of transducer, viewing direction, or other factors. For example, one or more beamforming parameters are set as a function of a user selected viewing direction for 3D imaging. The beamformer controller 16 is operative to set a scan plane position as a function of the viewing direction in one embodiment, but other parameters may alternatively or additionally be set as a function of the viewing direction.

In addition to the above listed beamforming parameters, a coherent image forming parameter based on phase differences for image forming may be set. For example, the weightings or other filtering used for coherent combinations of data from different elements for analytic filtering or analytic line interpolation is set as a function of the selected viewing direction.

The user interface 18 is one or more user input devices, such as a track ball, keyboard, buttons, knobs, sliders, mouse, touch pad, touch screen, or other now known or later developed user input devices. The user interface 18 also includes a controller for interacting with various components of the system 11, such as the beamformer 14 or beamformer controller 16. In alternative embodiments, the user interface 18 passes on a viewing direction to the beamformer controller 16 without further control processing. The user interface 18 also connects with the geometry processor 22 in one embodiment. Different or additional connections may be provided. The user inputs the viewing direction information by adjusting the user input. For 3D imaging, the viewing direction may be selected to be from any direction relative to the 3D volume. In alternative embodiments, the viewing direction is limited along one or more degrees of freedom or rotations. The selection of the viewing direction also indicates the display coordinate frame of reference. For volume rendering, a 2D representation of the 3D volume is rendered along a plane orthogonal to the viewing direction.

The detector 20 is a B-mode, M-mode, Doppler, color flow, motion, contrast agent, harmonic or other now known or later developed detector of ultrasound data. For example, the detector 20 is a B-mode detector for determining an intensity or magnitude of an envelope signal. As another example, the detector 20 is a Doppler detector for determining one or more of velocity, power, or variants estimates. In yet another embodiment, the detector 20 includes a plurality of different detectors.

The geometry processor 22 is a general processor, digital signal processor, application specific integrated circuit, digital circuit, analog circuit, combinations thereof or other now known or later developed geometry engine. In one embodiment, the geometry processor 22 is a 2D scan converter for converting between an acquisition or transducer based format (e.g., polar coordinate scan format) to a display format (e.g., Cartesian coordinate format). The control processor or other processor in the system may be used as the geometry processor 22. The geometry processor 22 is operable to receive data and interpolate the data to points on a different grid. The weights used for interpolation may be varied. The geometry processor 22 alters the geometry, such as by warping the acquired data to a new grid. In one embodiment, the geometry processor 22 is operable to foreshorten 2D areas and associated data corresponding to scan planes as a function of depth along the viewing direction. For example, the geometry processor 22 is operable to reduce a height associated with the scan plane or data set where the height corresponds to depth. The geometry processor 22 may also or alternatively alter the data along a different dimension. The geometry processor 22 is also operable to shift the 2D areas and associated data corresponding to the scan planes in depth along the viewing direction. For example, a foreshortened 2D area and associated interpolated data is shifted upwards or downwards along the height or depth dimension.

The filter 24 is a finite impulse response filter or an infinite impulse response filter. The filter 24 is an application specific integrated circuit, digital circuit, analog circuit, processor or other now known or later developed device for filtering data. In one embodiment, the filter 24 is a persistence filter for temporarily combining ultrasound data. In other embodiments, the filter 24 is a spatial filter. The filter 24 is operable to combine ultrasound data representing foreshortened and shifted 2D areas. For example, the filter 24 persists ultrasound data acquired at different times for different scan planes. The data persisted is associated with different amounts of foreshortening and shifting performed by the geometry processor 22. In yet another embodiment, the filter 24 is implemented as part of the display 26. A display plane memory receives sequential sets of data and persists the data together by averaging, adding, or otherwise displaying information from multiple sets of data at the same time on the display 26.

The display 26 is a CRT, LCD, flat panel, plasma, projector, or other now known or later developed display device. The display 26 is operable to display a 2D image representing a 3D volume. In one embodiment, various tools associated with 3D rendering or imaging are shown with the image. The user can select different viewing directions as graphically represented on the display. A 3D rendering is then performed to provide the 3D representation of the volume from the viewing direction. In one embodiment, real time imaging is provided by successively generating the plurality of images showing changes in the volume over time. By feeding back the user selected viewing direction for control of an acquisition parameter, the 3D representation may be improved or the four dimensional frame rate may be improved for real time imaging.

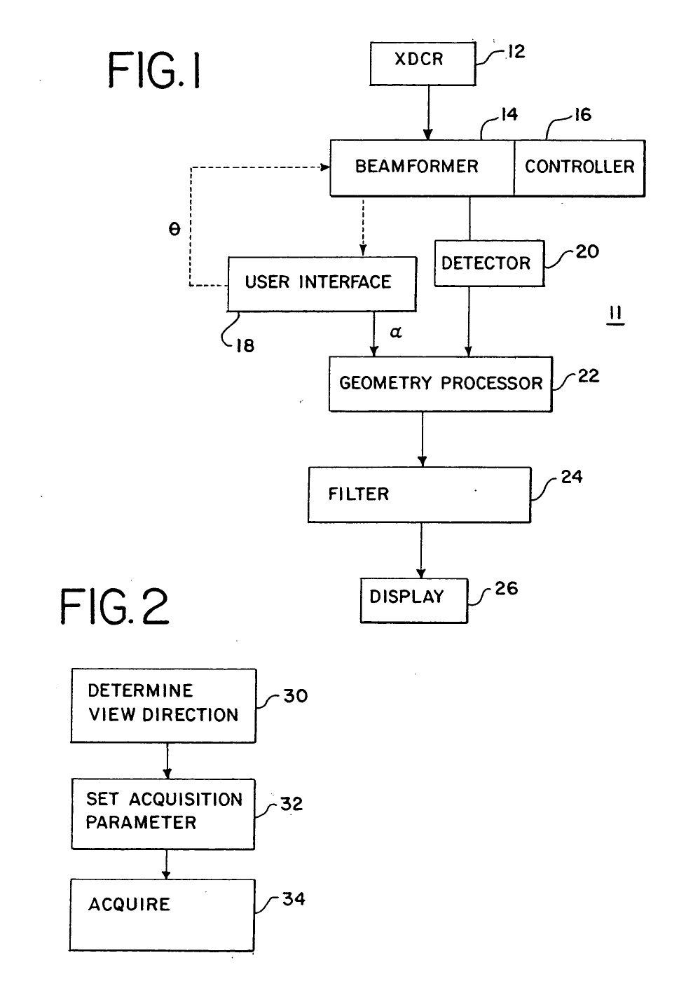

FIG. 2 shows one embodiment of a method for acquiring ultrasound data in volume rendering. Additional, different or fewer acts than shown in FIG. 2 may be provided in other embodiments.

In act 30, a viewing direction relative to a 3D space or volume is determined. The user selects the viewing direction. The selected direction is input to the system 11 or another system. The viewing direction is a direction to view the volume adjacent to the transducer 12. In one embodiment, the viewing direction is indicated and selected graphically by a user, but an angular input value may be provided. Any of various representations of a selected viewing direction may be used. A selected viewing direction is made as an initial step or is based on a subsequent change in the viewing direction. For example, the user may wish to alter the viewing direction while performing imaging. The altered viewing direction information is received as input from the user.

A parameter is set as a function of the input viewing direction in act 32, and ultrasound data is acquired in response to the set parameter in act 34. The ultrasound data acquired in act 34 is used for 3D rendering. Various rendering processes may be used. The discussion of acts 32 and 34 below address a specific rendering by setting beamformer parameters determining the scan plane positions as a function of the user selected viewing direction. A further discussion is then provided of other acquisition, beamforming, coherent imaging forming and/or image processing parameters that may be additionally or alternatively set as a function of the viewing direction.

In one embodiment, FIG. 2 represents a method for volume rendering for three or four dimensional imaging with ultrasound data using hardware or components available in 2D imaging systems. The scanning or acquisition coordinate system is established as a function of the viewing direction. The acquisition coordinate system is varied as the user's viewing direction varies. Each time the viewing direction changes, the acquisition coordinate system is set or reset and ultrasound data is acquired. The geometry engine, such as a scan converter is used to foreshorten and shift data representing 2D planes within the 3D volume. A persistence engine or filter blends in the 2D data representing different planes within the volume to form a 3D representation.

In act 32, an acquisition parameter is set as a function of the viewing direction. Any one or more of the acquisition parameters discussed herein are set in response to a given determination or setting of the view direction. For example, a transmit aperture position is set to be substantially perpendicular to the view direction along at least one dimension. As another example, a plurality of scan plane positions within a 3D volume are set as substantially perpendicular to the viewing direction along at least one dimension where each of the scan planes is spaced in a different position along the viewing direction.

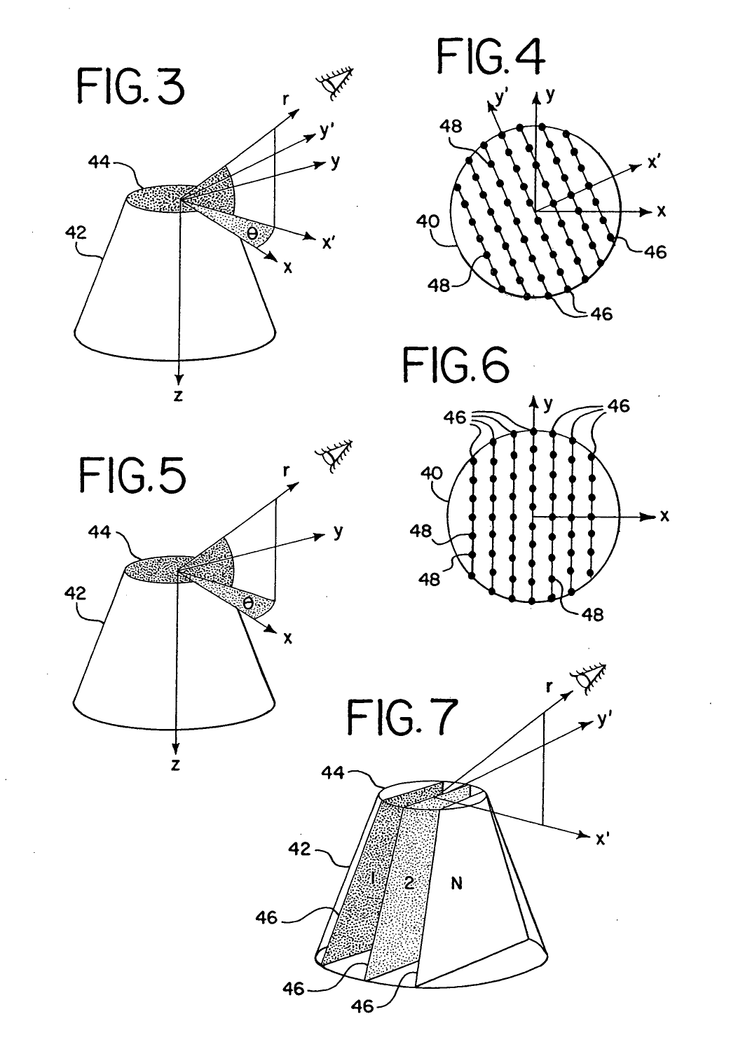

FIGS. 3 thru 6 show the spatial relationship between the transducer, the aperture, scan plane position, and the viewing direction. The scan volume 42 represents a conical volume to be scanned. In alternative embodiments, the volume 42 is of any of various shapes, such as cylindrical, perimetal, or cubical. The upper surface 44 of the volume 42 represents a position of the transducer 12. Typically, the x, y, and z dimensions are defined relative to the transducer, such as a z dimension representing depth, the x dimension representing elevation and the y dimension represent azimuth. FIG. 5 shows an example of a general coordinate system based on the transducer 12. FIG. 6 shows the line origins, i.e. the points at which the ultrasound lines 48 intersect the transducer surface 44 for this general case. The ultrasound lines 48 form scan planes 46. Additional or fewer scan planes 46 and/or transmit and/or receive beams 48 may be provided. While evenly spaced, the beams 48 and/or the scan planes 46 may have varying spacing.

FIG. 5 shows a vector r representing the arbitrarily selected viewing direction. Vector r is at an angle θ to the X dimension and an angle a to the plane formed by the x and y dimensions. The viewing direction vector r is described by the spherical coordinates as: r=(cos α cos θ, cos α sin θ, −sin α) with respect to the original coordinate system, (x, y, z).

The volume 42 is assigned a new coordinate system as a function of the viewing direction r. The new coordinate system is represented x′, y′, and z as shown FIGS. 3 and 4. x′ is given by (cos θ, sin θ, 0) and y′ is given by (−sin θ, cos θ, 0). The x dimension is transformed to the x′ dimension and the y dimension us transformed to the y′ dimension by the rotation within the x and y plane. y′ is then perpendicular to the shifted x dimension or x′. As a result, the coordinate system, (x′, y′, z), has the y′ axis perpendicular to the viewing direction. In alternative embodiments, the z dimension is also rotated and/or the x and y dimension are rotated closer to but not exact at angle θ. As shown in FIG. 4, the aperture, the scan planes 46 and associated transmit beams 48 are rotated as a function of the new coordinate system so that the lateral direction of each scan plane 46 is orthogonal to the viewing direction. The beamformer 14, beamformer controller 16, or other processor dynamically computes the coordinate system x′, y′, z according to the input user viewing direction. The scan planes 46 are provided by a transmit aperture, receive aperture and scan plane position that is altered as a function of the viewing direction.

In act 34, data, such as ultrasound data, is obtained as a function of the viewing direction based acquisition parameter prior to volume rendering or processing for volume rendering. The ultrasound data is obtained by scanning for new ultrasound data or processing previously acquired ultrasound data. For example, ultrasound data responsive to acquisition, beamforming, coherent image forming or image processing parameters is acquired by a scanning a patient with the system 10. As another example, ultrasound data responsive to image processing parameters is obtained by processing previously scanned or stored data as a function of the parameters. Ultrasound data responsive to any of the acquisition, beamforming, coherent image forming or image processing parameters may have been previously acquired and stored or may be acquired from a patient in response to the setting. The obtained data is then used for volume rendering, such as by interpolation to a 3D grid, combination of data from a given viewing direction or other volume rendering process. The acquired data represents the 3D space or volume 42. For example, FIG. 7 shows exemplary scan planes 1, 2 thru N where n is equal to 3. Ultrasound data is acquired representing each of the scan planes 46. In other embodiments, n is 2 or greater then 3. The scan planes 46 are generated by steering each plane around the y′ dimension by an angular increment that is equally spaced throughout the volume 42, but unequal steering angular increments may be used. The scan planes 46 may also be parallel. As shown, the lateral direction of the scan planes 46 are orthogonal to the viewing direction, r.

In one embodiment, the ultrasound data for the scan planes is acquired starting from the scan plane 46 farthest from the virtual viewer, such as a scan plane 1 and progressing closer to the virtual viewer, such as to the scan plane N. In alternative embodiments, different orders of acquisition of the data may be provided.

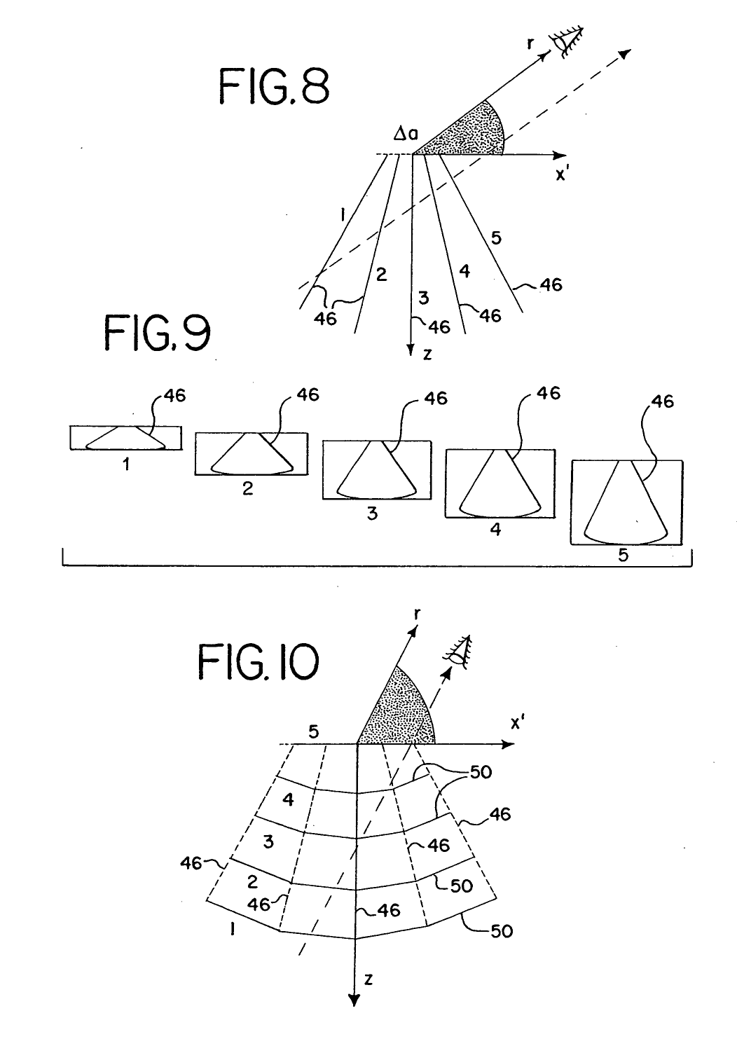

The acquired ultrasound data is 2D scan converted in each of the scan planes, resulting in a series of 2D images. These 2D images are then foreshortened and shifted prior to blending together to form volume-rendered images. The foreshortening and shifting are functions of the angle of the viewing direction to each of the scan planes. FIG. 8 shows five scan planes 46, each at a different angle to the viewing direction r in x′, z. FIG. 8 represents a cross-sectional view containing x′ and z dimensions. The foreshortening and shifting account for the difference in perspective to the viewer of each of the scan plane's spatial extent. For example, the scan plane 1 appears shorter and higher up than scan plane 2 as viewed from the viewing direction r. The foreshortening and shifting is in addition to the 2D scan-conversion performed for converting from an acquisition or polar coordinate format to a display or cartesian coordinate format. In the example shown in FIG. 8, the ultrasound data of each 2D scan plane 46 is foreshortened by a factor of cos(α−(i−3)Δβ) along the vertical direction of the display where i=1 through 5 and Δβ is the elevation steering angle increment of the x′, y′, z coordinate system. In alternative embodiments, the foreshortening, shifting, and/or coordinate based interpolation are performed sequentially or separately using a same or different hardware components.

The ultrasound data representing the 2D areas of each respective scan plane 46 is foreshortened by different amounts. Foreshortening compresses or expands the area along the z dimension represented by the ultrasound data. For example, FIG. 9 shows the five scan planes 46 of FIG. 8. Each of the scan planes 46 is foreshortened to a different height as a function of the viewing direction. The amount of foreshortening is a function of the perceived height of the respective scan plane along the viewing direction. The scan plane closest to the viewer and most orthogonal to the viewer, scan plane 5 in FIGS. 8 and 9, appears to be the tallest. In other embodiments, other scan planes than the closest scan plane to the viewer appears as the tallest. The 2D areas corresponding to the 2D scans are foreshortened as a function of depth along the viewing direction as shown in FIG. 9. Different, additional or less foreshortening may be provided for any 1, subset or all of the sets of ultrasound data representing the scan planes 46.

If the 3D ultrasound imaging is performed using the sector format, shifting may be avoided; only the foreshortening stage is performed. Furthermore since other scan formats, such as Vector®, Curve-Linear® and Curved Vector®, may be expressed in the sector format by re-sampling and zero padding of data along the acoustic lines, in some cases, foreshortening is performed without shifting for these other formats.

In additional or as an alternative to foreshortening, each of the 2D areas and associated ultrasound data are shifted relative to the other 2D areas or scan planes 46. The amount of shift is a function of a perceived position of the respective scan plane 46 along the viewing direction r. The amount of shift is given by (i−3) Δa sin α where Δa is the separation of the 2D scan planes 46 at the transducer 12. Different, greater or lesser amounts of shift may used. The shift is along the vertical or z dimension. The area represented by the data is shifted as a function of depth along the viewing direction. FIG. 9 shows each of the scan planes shifted relative to each other based on the viewing direction. Since the scan plane 1 appears higher then the other scan planes from the viewing direction shown in FIG. 8, the scan plane 1 is shifted to be in a higher location then the other four scan planes 46. Different relative shifts may result where the face of the transducer is curved or viewing direction is different. Since both the foreshortening and shifting are performed for 2D regions, a 2D scan converter or other geometric engine is operable to perform both shortening and shifting sequentially or simultaneously.

The ultrasound data for the foreshortened and shifted 2D areas is combined. For simplicity of combination, the ultrasound data for each of the scan planes 46 is persisted or combined over time as each of the sets of data is acquired. In one embodiment, a persistence filter performs the combination. A persistence engine or filter combines the data for each of the scan planes 46 prior to generating an image. Any of various persistence functions may be used, such as an infinite impulse response or finite impulse response combination. A recursive weighted sum is performed in one embodiment. For example, the persistence engine combines the images according to the equation:
Pi=f(Iᵢ)P_{I-1}+g(Iᵢ),
where P_{I-1} is the pixel content after the i−1^{th} 2D image is rendered, Iᵢ, is the ith 2D image, f(Iᵢ) is an opacity function and g(Iᵢ) is a transfer function. Any of various opacity or transfer functions may be used. For example, the transfer function is a ramp, gaussian, or any other function ranging between 0 and 1. One example implementation is given by:
Pi=(255−Ii)Pᵢ₋₁/255+Iᵢ
where 255 represents the possible pixel values on the display. Pᵢ is the value of the frame buffer after blending with the i^{th} 2D image. Other persistence or combination may used, such as disclosed in U.S. Pat. No. ______ (application Ser. No. 10/388,128), the disclosure of which is incorporated herein by reference. Other filters or processors may be used. For example, the foreshortened and shifted ultrasound data is rendered to the display as an image. Subsequent images are then also rendered to the display. As a result of rendering multiple images to the display at the same time, the display persists the data and combines the data.

In one embodiment, the filtering is weighted as a function of the number of component sets of ultrasound data representing each given pixel location. Different weights are used where different numbers of ultrasound scan planes or data for 2D areas overlap a pixel. In alternative embodiments, the ultrasound data is combined only for areas where all of the component scan planes overlap. A low pass or other spatial filtering may be used to remove any combination or persistence artifacts.

The combined ultrasound data is used to generate an image. The image is a 3D representation of the scanned volume 42. By adaptively altering acquisition parameters, such as apertures or other parameters affecting a scan plane position, as a function of the viewing direction, the 3D representation is generated using a geometric engine and a persistence engine operable on 2D images. The representation is generated free of interpolation to a 3D grid or other highly computationally intensive processes for rendering. By orienting the acquisition scan planes or apertures to the view direction rather then to the transducer array layout, 3D or four dimensional imaging is provided with 2D processes.

The arrangement of data used for foreshortening, shifting and combining varies as a function of the viewing direction in one embodiment. As shown in FIG. 8, the angle α of the viewing direction vector r to the x′ axis is small enough that a line parallel to the viewing direction intersects each of the scan planes 46. As shown in FIG. 10, a larger angle a may result in a viewing direction vector r which intersects only some of the scan planes 46. In one embodiment, a subset of all of the scan-planes 46 is selected for generating a 3D representation as discussed above. Alternatively, a series of shells 50 representing a same depth along the z axis, a constant range value, or other C scan planes are defined. The shells 50 extend across the plurality of scan planes 46 as shown in FIG. 10. The data representing each of the shells 50 is selected from the frames of data acquired for each of the scan planes 46. The shells 50 and corresponding selected ultrasound data are foreshortened and shifted as discussed above. Where the shells 50 are curved surfaces rather then planar surfaces, each planar subsection of the shells 50 are foreshortened and shifted separately. Alternatively, a smoothly varying shell 50 is foreshortened and shifted as a function of the location along the shell 60. Since the scan planes 46 are aligned relative to the viewing direction, foreshortening and shifting of the shells is along a single dimension, such as the x′ direction from the viewing direction perspective or vertical direction for a display perspective.

In another embodiment, the scan planes 46 shown in FIG. 7 are foreshortened and/or shifted prior to the 2D scan conversion. In this case, the foreshortening and/or shifting are done in the acoustic domain. Since all the acoustic lines in a given scan plane 46 lie on a 3D plane, these acoustic lines are foreshortened to the viewer by the same amount. The foreshortened and/or shifted acoustic scan planes are then blended using the persistence engine as before. The resulting image is then 2D scan-converted to generate the volume rendered image.

A user centric coordinate system for the beamformer and transducer provides volume rendering using 2D geometry and persistence engines without interpolation to a 3D grid or other 3D based rendering processes. Ultrasound data acquired along scan planes oriented relative to the view direction is shear warped for three or four dimensional imaging. Lower cost hardware, already used in 2D hardware or other components may be used in a simple embodiment to provide three or four dimensional volume rendering at rates suitable for cardiology. 3D imaging hardware is alternatively used.

One or more parameters for acquisition, beamforming, coherent image forming, image processing and combinations thereof are set as a function of the viewing direction. In the embodiments discussed above, acquisition parameters operable to control a position of the apertures or scan planes are set as a function of the user selected viewing direction. Other parameters are set in addition or as alternatives to the acquisition parameters discussed above. For example, additional acquisition, beamforming, coherent image forming or image processing parameters are also set as a function of the viewing direction in the embodiments discussed above. As another example, any of the various parameters discussed herein are set for performing three or four dimensional volume rendering without aligning the scan planes to the view direction, such as in now known volume rendering.

For volume rendering, data along a viewing axis is combined. As a result of the combination, information along the viewing axis is lost. Due to the different processes performed as a function of the viewing direction, data with different characteristics is desired for spatial locations spaced parallel to the viewing direction as opposed to perpendicular to the viewing direction. For data along a display azimuth axis substantially perpendicular to the viewing direction, parameters are set for reducing artifacts, increasing detail resolution, and increasing the field of view. For data spaced substantially parallel to the viewing direction along a display elevation axis, parameters are set for increasing or providing sufficient contrast resolution but decreased detail and temporal resolution may be provided. The increases and decreases discussed above are an increase or decrease along one dimension relative to the settings provided along a different dimension. A subset, none or different effects of setting the parameters may be provided.

In one embodiment, one or more acquisition parameters are set as a function of the viewing direction. The acquisition parameters are the parameters that control the scan geometry, scan pattern, firing sequence, data-sampling rate (e.g., beam density, lateral sampling grid and beam distribution), etc. The example above shows setting positions of a set of scan planes as a function of the viewing direction.

The sampling grid provided by the beamformer is set as a function of viewing direction in one embodiment. For example, a lower line density is provided along the elevation display axis or viewing direction as compared to perpendicular to the viewing direction. The distribution scheme may be different as a function of the viewing direction, such as providing less density at the edges of a scan along the azimuth position. As another example, different scan formats are used as a function of the viewing direction. As yet another example, the number of range samples for any given distance is different along one dimension then for another dimension as a function of the viewing angle. In one embodiment, a vector scan format (e.g., an apex anywhere except at the transducer) is provided in the azimuth display dimension and a sector scan (e.g., apex at the transducer) is provided in the elevation dimension.

In one embodiment, one or more beamformer parameters are set as a function of the viewing direction. Now known or later developed beamformer parameters or values programmable for a beamformer or other components affecting temporal response of a beam are set. In one embodiment, the transmit and/or receive apodization is more tapered along the display elevation dimension or parallel to the viewing direction. Off axis clutter is reduced in elevation, but at a possible sacrifice of detail resolution. A more tapered apodization is provided by a Hamming or other window function with reduced values at the edge of the aperture. Apodization along the display azimuth dimension has less tapering or higher edge values. The tapering may reduce side lobes while increasing a main lobe width, allowing for fewer scan lines as a function of elevation without aliasing as compared to the number of scan lines used for increased detail resolution along the display azimuth dimension.

Transmit and/or receive focusing is varied as a function of the viewing direction. Weaker focusing is provided along the elevation display dimension as compared to the azimuth display dimension. For example, the focus along the elevation dimension is spread, such as providing a line focus as compared to a point focus. As another example, the number of simultaneous transmit or receive beams is greater along the elevation dimension then the azimuth dimension. As a result, multi-beam artifacts are limited along the azimuth display dimension. Along the elevation display dimension, the multi-beam artifacts are less likely to result in image artifacts due to the averaging or combination along the elevation or viewing direction for rendering. As yet another example, a transmit or receive beam is wider along the elevation dimension then the azimuth display dimension. As yet another example, a compound focus is provided along the azimuth dimension but only one focus or fewer foci are provided along the elevation dimension. Other differences in focusing may be provided. The delay profile, apodization profile, waveforms or other characteristics are altered to provide the focusing discussed herein.

In one embodiment, the transmit or receive frequency is different for the different directions relative to the viewing direction. For example, an imaging frequency is varied as a function of the steering angle in the display azimuth dimension but not in the elevation azimuth dimension. In one embodiment, the adjustable frequency scanning disclosed in U.S. Pat. No. 5,549,111, the disclosure of which is incorporated herein by reference, is performed along the scan lines spaced along the azimuth display axis and is not performed or is performed differently for scan lines spaced in the elevation display axis. The receive frequency, transmit frequency or combinations thereof are varied as a function of the viewing direction.

Complex phase and/or amplitude aperture patterns are varied or set to be different as a function of the viewing direction. Different apodization or delay patterns for apertures across the azimuthal display dimension are different than elevation aperture patterns parallel to the viewing direction.

A coherent image forming parameter is set as a function of the viewing direction in additional or alternative embodiments. The coherent image forming parameter is implemented by the beamformer or other processor accounting for differences in phase between data received at elements or between scan lines. For example, an amount of coherent summation across an azimuth display dimension of beams responsive to different transmit events is varied as a function of the user selected viewing direction. Predetected coherent data is summed or weighted and summed across the azimuthal axis for overlapping received beams where each of the beams is responsive to a different transmit beam. The resulting interpolated or filtered information provides for data representing an already existing scan line or data representing a scan line between received beams. In the elevation dimension, no coherent summation is provided or incoherent summation is provided. Any of various coherent image formation processing may be used and varied as a function of the viewing direction.

In additional or alternative embodiments, one or more image processing parameters are set as a function of the user selected viewing direction. One image processing parameter is the amount of spatial compounding. For example, steered spatial compounding is provided for data spaced along the elevation display dimension but not in the azimuthal display dimension. Steered spatial compounding is performed by acquiring data representing the same location from different transmit steering angles. The information is then compounded or combined. Rather then an absolute compounding or no compounding as a function of dimension or viewing direction, weights or other characteristics of spatial compounding are adjusted relative to each other for performing spatial compounding in both dimensions.

Another image processing parameter is an amount of incoherent summation, such as summation of information representing elevationally spaced beams responsive to different transmit events. Incoherent summation provides for image formation using detected data with the phase information removed. A different amount or no incoherent summation is provided across the azimuthal dimension. As an alternative or in addition to image formation as a function of the receive beam, incoherent beamformation is provided where appropriately delayed signals from different elements are incoherently summed or weighted and summed. The weighting or other incoherent summation factor is changed as a function of the viewing direction. For example, a coherent summation of appropriately delayed signals from elements is performed along the azimuthal direction, but incoherent summation is provided along the elevation direction. In this embodiment, signals from the elements are coherently summed in the azimuthal direction and then the results are detected. The detected signals representing each of the elements or a coherently formed virtual element is then summed across the elevation dimension. The summed signals are then used to beamform samples representing the scan volume.

Another image processing parameter is the amount of lateral filtering. For example, more smoothing is provided along the viewing direction then perpendicular to the viewing direction. Different low pass filters or filter parameters are adjusted to provide more or less lateral filtering along the viewing direction then perpendicular to the viewing direction.

Another image processing parameter is an amount of lateral gain. For example, gain adapted to equalize tissue signals is applied as function of the user selected viewing direction. In one embodiment, no or different lateral gain is applied along the elevation or viewing direction as compared to applying a tissue equalization or other gain along an azimuthal and depth directions perpendicular to the viewing direction. The depth dependent or other lateral gains may vary as a function of the viewing direction.

Another image processing parameter is an adaptive processing value. Values or algorithms used for different adaptive processing are different as a function of the viewing direction. Signal-to-noise ratio, coherence factor, speckle, amplitude or other processes or algorithms are adaptive to receive data. Other now known or later developed adaptive processes may be provided. The adaptive processing is varied or set different as a function of a viewing direction. For example, one adaptive process is provided for data parallel to the viewing direction and not for perpendicular or vis versa. As another example, a different level, amount, type, characteristic or formula is applied for adaptive processing as a function of the viewing direction. In one embodiment, adaptive processes operable to reduce resolution are performed more in elevation or parallel to the viewing direction then perpendicular to the viewing direction. Adaptive processes increasing the level of detail are performed more or only along dimensions perpendicular to the viewing direction than parallel to the viewing direction.

Another image processing parameter is a value affecting axial response. Where the viewing direction changes from a side of a volume to a top or bottom of the volume, the actual response or associated bandwidth for imaging is varied. Lower bandwidth imaging is used for viewing directions from the top or bottom of the volume where the top is associated with a transducer position. Where the viewing direction is at a side to the volume, higher bandwidth imaging is provided for better detail resolution.

Another image processing parameter is the sample volume used for generating a 3D representation. For example, an asymmetric sample volume is used for rendering. The asymmetric volume is rotated as a function of the viewing direction. For example, the asymmetric volume is defined to limit the amount of information in parallel to the viewing direction used for volume rendering. By rotating the asymmetric volume, the same amount of information is used for rendering from different viewing directions. Other image processing parameters now known or later developed may be used.

Ultrasound data or other medical imaging data is obtained as a function of an image processing parameter, coherent image forming parameter, acquisition parameter and/or beamformer parameter. The parameters are varied or set in dependence on the user selected viewing direction. The user selected viewing direction is fed back to any of the various components of the system 11 of FIG. 1 or components of a different system for altering processing, beamforming, acquisition, coherent image formation, combinations thereof or other parameters. The data obtained in response to the various parameters is then used for generating three or four dimensional images. Since the viewing direction is feed back for acquisition of or obtaining image data, the viewing direction is used to alter scanning or processing as a function of the direction of the viewing the scanned volume. Scanning may include image and other processing used to acquire the data for rendering.

While the invention has been described above by reference to various embodiments, it should be understood that many changes and modifications can be made without departing from the scope of the invention. It is therefore intended that the foregoing detailed description be regarded as illustrative rather then limiting, and that it be understood that it is the following claims, including all equivalents, that are intended to define the spirit and scope of this invention.

1. A method for acquiring ultrasound data in volume rendering, the method comprising:
(a) determining a viewing direction relative to a 3D space;
(b) setting at least one parameter selected from a group of acquisition, beamforming, coherent image forming and image processing parameters as a function of the viewing direction; and
(c) obtaining ultrasound data as a function of the at least one parameter prior to volume rendering, the ultrasound data representing the 3D space.

2. The method of claim 1 wherein (a) comprises receiving input from a user selecting the viewing direction, the 3D space being a volume adjacent to a transducer.

3. The method of claim 1 wherein (b) comprises setting the lateral axes of a plurality of scan planes as substantially perpendicular to the viewing direction, each scan plane of the plurality of scan planes spaced at a different position along the axis parallel to the viewing direction, and wherein (c) comprises acquiring ultrasound data representing the scan planes.

4. The method of claim 3 further comprising:
(d) foreshortening the ultrasound data for each of the scan planes, the foreshortening for each of the scan planes being a function of an angle of the viewing direction to each of the scan planes.

5. The method of claim 3 further comprising:
(d) shifting each of 2D areas representing respective scan planes relative to the other 2D areas as a function of a perceived position of the respective scan plane along the viewing direction.

6. The method of claim 5 further comprising:
(e) combining the ultrasound data for the foreshortened and shifted 2D areas.

7. The method of claim 3 further comprising:
(d) persisting the ultrasound data for each of the scan planes together.

8. The method of claim 3 further comprising:
(d) determining a plurality of shells extending across the plurality of scan planes; and
(e) rendering from the ultrasound data representing the plurality of shells.

9. The method of claim 1 wherein (b) and (c) comprise establishing a scanning coordinate system as a function of the viewing direction.

10. The method of claim 1 further comprising:
(d) changing the viewing direction; and
(e) repeating (b) and (c) in response to (d).

11. The method of claim 1 wherein (b) comprises setting an acquisition parameter selected from the group of: lateral sampling grid, scan geometry, scan pattern, firing sequence, data-sampling rate and combinations thereof;
wherein (c) comprises obtaining the ultrasound data as a function of the acquisition parameter.

12. The method of claim 1 wherein (b) comprises setting a beamforming parameter selected from the group of: transmit apodization, receive apodization, transmit focus, receive focus, number of substantially simultaneous transmit beams, number of substantially simultaneous receive beams, transmit frequency, receive frequency, cyclic phase aperture pattern, cyclic amplitude aperture pattern, and combinations thereof;
wherein (c) comprises obtaining the ultrasound data as a function of the beamforming parameter.

13. The method of claim 1 wherein (b) comprises setting a coherent image forming parameter selected from the group of: an amount of lateral coherent processing in azimuth of beams, lateral filter variable, interpolation prior to amplitude detection and combinations thereof;
wherein (c) comprises obtaining the ultrasound data as a function of the phase difference image forming parameter.

14. The method of claim 1 wherein (b) comprises setting an image processing parameters selected from the group of: an amount of spatial compounding, post-detection beam averaging, an amount of frequency compounding, an amount of lateral filtering, an amount of lateral gain, an adaptive processing value, an axial response value, an amount of incoherent summation in elevation of beams responsive to different transmit events and combinations thereof;
wherein (c) comprises acquiring the ultrasound data as a function of the image processing parameter.

15. A method for acquiring ultrasound data in volume rendering, the method comprising:
(a) determining a viewing direction relative to a 3D space; and
(b) setting a parameter for one of: an acquisition, a beamforming, a coherent image forming, an image processing and combinations thereof as a function of the viewing direction.

16. The method of claim 15 further comprising:
(c) performing at least one of reducing artifacts, increasing detail resolution and increasing a field of view along a display azimuth axis substantially perpendicular to the viewing direction by setting the parameter; and
(d) performing one of increasing contrast and reducing temporal resolution along a display elevation axis substantially parallel to the viewing direction set by setting the parameter.

17. A method for volume rendering with ultrasound data, the method comprising:
(a) determining a viewing direction relative to a 3D space; and
(b) performing 2D scans along planes substantially perpendicular to the viewing direction along at least one dimension;
(c) foreshortening 2D areas corresponding to the 2D scans as a function of depth along the viewing direction;
(d) combining the ultrasound data representing the foreshortened 2D areas; and
(e) generating a 3D representation from the combined ultrasound data.

18. The method of claim 17 further comprising:
(f) shifting the 2D areas corresponding to the 2D scans in depth along the viewing direction prior to (d);

19. The method of claim 17 wherein (f) is performed free of interpolation to a 3D grid.

20. The method of claim 17 wherein (c) and (d) are performed by a 2D scan converter and (e) is performed by a persistence filter.

21. A system for 3D imaging of ultrasound data, the system comprising:
a beamformer;
an acquisition controller connected with the beamformer;
a transducer connected with the beamformer; and
a user input operative to receive a selected viewing direction;
the acquisition controller operative to set a parameter of the beamformer as a function of the selected viewing direction.

21. The system of claim 20 wherein the acquisition controller is operative to set one of a beamformer parameter and a coherent image forming parameter.

22. The system of claim 20 wherein the acquisition controller is operative to set scan plane positions as a function of the selected viewing direction.

23. The system of claim 22 further comprising:
a processor operable to foreshorten 2D areas corresponding to scan planes as a function of depth along the viewing direction and shift the 2D areas corresponding to the scan planes as a function of depth along the viewing direction;
a filter operable to combine the ultrasound data representing the foreshortened and shifted 2D areas; and
a display operable to generate a 3D representation from the combined ultrasound data.

24. The method of claim 17 wherein (c) comprises foreshortening in the acoustic domain.

25. The method of claim 18 wherein (f) comprises shifting in the acoustic domain.

26. The method of claim 24 wherein (e) comprises scan converting.
